(19) United States
(12) Patent Application Publication
(10) Pub. No.: US 2026/0065302 A1
(43) Pub. Date: Mar. 5, 2026

(54) Computer-implemented Method for Global Holdout Testing and Related Systems

(71) Applicant: Klaviyo, Inc., Boston, MA (US)

(72) Inventors: Justin Xu, Mountain View, CA (US); Carola Leiva, Boston, MA (US); Jack Cosgrove, Boston, MA (US)

(21) Appl. No.: 19/285,676

(22) Filed: Jul. 30, 2025

Related U.S. Application Data
(60) Provisional application No. 63/687,476, filed on Aug. 27, 2024.

(51) Int. Cl. G06Q 30/0201

(52) U.S. Cl. CPC G06Q 30/020112

(57) ABSTRACT

A computer-implemented method for computing a lift value for multiple types of electronic messaging strategies is based on global holdout group testing. A set of preprocessing rules and an optional classifier are applied to identify the total number of valid profile base objects available for testing. The total number of valid profile base objects are assigned to the holdout group and the non-holdout group. Raw events are joined with the group events. An analytics engine computes the conversions rates such as lift value and win probability.

### RELATED APPLICATIONS

This claims priority to application No. 63/687,476, filed Aug. 27, 2024, and entitled “Computer-implemented Method for Global Holdout Testing and Related Systems”, the entirety of which is incorporated by reference in its entirety for all purposes.

### TECHNICAL FIELD

This relates to computer data processing, and more particularly, to computer-implemented methods for building experiments to test electronic message performance and to analyze the data arising from the experiments.

### BACKGROUND

It is desirable to test and evaluate the impact an electronic message has on its recipient. One technique for testing includes the use of holdout groups. Holdout groups in testing are a subset of recipients who are not exposed to the experimental treatment or changes being tested. This group serves as a control to compare against the treated group, allowing for a clearer understanding of the treatment's impact.

For example, if one is testing the effectiveness of a new email campaign, one group receives the new campaign (the treatment group) and a second group does not receive it (the holdout group). By comparing the behavior and conversion rates of both groups, a truer impact of the new campaign can be determined.

Holdout groups are particularly useful for measuring the incremental value of marketing efforts beyond just improvements between two versions, namely, A/B testing. They can help quantify “lift”—the increase in revenue compared to doing nothing.

However, a number of challenges exist using holdout groups. Holdout groups by definition exclude a portion (potentially a statistically significant portion) of an audience. Consequently, doing so only makes sense for a threshold audience size.

Additionally, conventional holdout testing generally addresses only one type of electronic messaging strategy (e.g., a one-time manual email sends). Other messaging strategies (e.g., automatic message sends based on a trigger event) may be desirable to include in the testing and may have an impact on the behavior of the recipients.

Additionally, testing for email-only delivery is limited. Other electronic channels (e.g., SMS) may be desirable to include in the testing and can have an impact on the behavior of the recipient.

Additionally, even if a holdout group is assigned, it may be desirable to still deliver certain electronic messages to the members of the holdout group for various reasons, not the least of which confirmation of a purchase or payment. The lack of modifications or exceptions is undesirable in prior holdout testing.

Accordingly, a method and system that addresses the above-mentioned challenges is desired.

### SUMMARY OF THE INVENTION

An embodiment of the invention is a computer-implemented method of computing lift arising from global holdout testing.

In embodiments, a method for computing lift arising from global holdout testing comprises: receiving a plurality of testing parameters comprising holdout percentage for a holdout group and test duration; selecting electronic message sending strategies to override from the holdout group; retrieving, from a profile base object database valid profile base objects; preprocessing the valid profile base objects based on a set of exclusion rules; assigning a first set of profile base objects to the holdout group and a second set of profile base objects to the non-holdout group; publishing asynchronously, in batches, assigned membership event base objects corresponding to the profile base objects in the holdout group and the profile base objects in the non-holdout group; joining, by a profile ID, the assigned membership event base objects and unassigned raw event base objects received from a raw event pipeline, thereby creating an updated set of assigned event base objects for the holdout group and for the non-holdout group; calculating total counts of the assigned event base objects in the holdout group and total counts of the assigned event base objects in the non-holdout group; calculating conversion counts of conversion events of the assigned event base objects in the holdout group and conversion counts of the conversion events of the assigned event base objects in the non-holdout group; and computing, on a backend server, at least one conversion rate based on the test duration, conversion counts, and total counts.

In embodiments, a system for computing lift for global holdout testing comprises: a raw event database operable to manage raw event base objects arising from sub-user behaviors; a profile database operable to manage profile base objects corresponding to the sub-users; a holdout compute engine operable to assign the profile base objects to a holdout group and to a non-holdout group; a membership database operable to: manage membership change events, and to arrange and store the profile base objects of the sub-users according to holdout group and a non-holdout group; publish assigned membership event base objects corresponding to each of the profile base objects in the holdout group and the profile base objects in the non-holdout group; join, by sub-user, unassigned raw event base objects with the assigned membership event base objects and create an updated set of assigned event base objects for the holdout group and for the non-holdout group; a user interface module operable to request testing parameters comprising holdout percentage for a holdout group, and test duration; and wherein the holdout compute engine is further operable to: request, from the membership database, total counts of the assigned event base objects in the holdout group and total counts of the assigned event base objects in the non-holdout group; request, from the membership database, conversion counts of the conversion events for the assigned event base objects in the holdout group and conversion counts for the conversion events for the assigned event base objects in the non-holdout group; and compute at least one conversion rate based on the test duration, conversion counts, and total counts.

In embodiments, the conversion count is based on a statistic type selected from the group comprising ordered product, purchases, open carts, and checkouts started.

In embodiments, the messaging strategy types include one-time manual message sends (e.g., campaigns) and automatic sends based on trigger events (e.g., flows).

In embodiments, the selecting is performed by a selector model operable to classify candidates to override from the holdout group.

In embodiments, the selector model is a rule-based model or trained machine learning model.

In embodiments, the assigning is performed by a hashing algorithm.

In embodiments, the holdout compute engine is operable to assign in real-time within volatile memory structures without committing data to persistent storage mediums

In embodiments, the win probability is also computed, and optionally, based on the Bayes' formula.

In embodiments, the selecting comprises identifying messages automatically triggered based on a sub-user detected behavior, optionally, an order or purchase.

In embodiments, the exclusion rules are based on excluding profile base objects from testing unless a first type of sub-user behavior is detected/confirmed (namely, an explicit consent to receive a SMS or push messages).

In embodiments, a non-transitory machine-readable medium, comprising executable instructions that, when executed by a processing system including a processor, perform operations for computing lift. The operations comprise: selecting electronic message sending strategies to override from a holdout group; retrieve, from a profile base object database valid profile base objects; preprocessing the valid profile base objects based on a set of exclusion rules; assigning a profile base objects to the holdout group and profile base objects to the non-holdout group; publishing asynchronously, in batches, assigned membership event base objects corresponding to the profile base objects in the holdout group and the profile base objects in the non-holdout group; joining, by a profile ID, the assigned membership event base objects and unassigned raw event base objects received from a raw event pipeline, and creating an updated set of assigned event base objects in the holdout group and in the non-holdout group; getting total counts of the assigned event base objects in the holdout group and total counts of the assigned event base objects in the non-holdout group; getting conversion counts of conversion events of the assigned event base objects in the holdout group and conversion counts of the conversion events of the assigned event base objects in the non-holdout group; and computing, on a backend server, at least one conversion rate based on the test duration, conversion counts, and total counts.

In embodiments, a statistic type is requested from the user for computing the conversions.

In embodiments, the profile base object database, the audience or membership database, the raw event base object database, the joining operations, and the getting or counting operations are all implemented by a cloud database service operable to perform computer operations using virtual machines or computers for optimizing resources and efficiency.

In embodiments, a computer-implemented method for computing a lift value for global holdout testing, wherein the global holdout testing measures conversions for multiple types of electronic messages and sending strategies, the method comprising: receiving a plurality of testing parameters comprising holdout percentage for a holdout group and test duration; selecting electronic message sending strategies to override from the holdout group; retrieve, from a profile base object database, valid profile base objects; preprocessing the valid profile base objects based on a set of exclusion rules; assigning, by a server, profile base objects to the holdout group and profile base objects to the non-holdout group; creating an updated set of event base objects for the holdout group and the non-holdout group based on matching, by profile, assigned membership event base objects and unassigned raw event base objects received from a raw event pipeline; calculating total counts of the event base objects in the holdout group and total counts of the event base objects in the non-holdout group; calculating conversion counts of conversion events for the event base objects in the holdout group and conversion counts for conversion events for the event base objects in the non-holdout group; and computing, by the server, at least one conversion rate based on the test duration, conversion counts, and total counts.

### Objects and Advantages

Embodiments of the invention have a variety of objects and advantages. For example, embodiments of the invention test across multiple technology types (namely, globally) of electronic messaging and content such as emails, SMS and push notifications as well as all types of electronic messaging strategies (e.g., one-time message sends as well as sends based on automatic trigger events).

Embodiments of the invention provide flexibility and customization to permit or exclude select base objects or categories of base objects from the holdout group.

Embodiments of the invention improve speed and efficiency of the computer resources by preprocessing the number of profile base objects to reduce the size, and apply a fast algorithm to determine which base objects shall be in the holdout group and which objects shall not be in the holdout group.

Embodiments of the invention are domain agnostic. Assignment of the sub-users to the holdout group is computed for the lift computation on a standalone server—and need not be stored as a sub-user profile property in the existing sub-user profile databases. Consequently, the sub-user records and related database need not be affected by this downstream holdout assignment computation as described herein.

In embodiments, the hashing algorithm allows profiles to be assigned to a holdout group on the fly without persisting storage.

In embodiments, the hash is based on both the profile id and the holdout group id, so that different holdouts will contain a different, random set of profiles subject to the holdout percentage.

In embodiments, there is only one global holdout experiment at a time.

In embodiments, holdout membership can be quickly computed without querying a datastore, so this is resilient both to scaling problems and infrastructure downtime (e.g. the database is down). This makes ascertainment of holdout membership fast and resilient, without affecting other parts of the pipeline.

In embodiments, the storage of profile ids in the audience datastore is strictly for analytics purposes and can be processed asynchronously, reducing the burden for online systems.

In embodiments of the invention, holdout membership is computed by hashing, making the system performant, resilient, and modular.

In embodiments of the invention, holdout analytics events are processed asynchronously, reducing the online load of the system and making the holdout experiment UX more performant.

In embodiments of the invention, holdout analytics are computed online every time the analytics are requested, and if they are satisfactory the holdout experiment can be ended earlier than planned.

In embodiments of the invention, holdout exclusion rules include channel permissions (accepts email, SMS, push, etc.) as well as VIP membership.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings in which:

FIG. 1 is a schematic diagram of a lift computation system, according to one or more embodiments of the present invention;

FIG. 2 is a flow chart of an overview for computing lift, according to one or more embodiments of the present invention;

FIG. 3 is another flow chart of a method for computing lift, according to one or more embodiments of the present invention;

FIGS. 4A-4B are examples of assigned membership event and unassigned raw event records corresponding to the audience pipeline and raw event pipeline respectively;

FIG. 5 is a GUI showing a lift report, according to one or more embodiments of the present invention; and

FIG. 6 is a block diagram of a computing system that can implement one or more of the steps described herein, according to one or more embodiments of the present invention.

### DETAILED DESCRIPTION

Before the present invention is described in greater detail, it is to be understood that this invention is not limited to particular embodiments described, and as such can, of course, vary. It is also to be understood that the terminology used herein is for the purpose of describing particular embodiments only, and is not intended to be limiting, since the scope of the present invention will be limited only by the appended claims. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described. It is noted that, as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation. As will be apparent to those of skill in the art upon reading this disclosure, each of the individual embodiments described and illustrated herein has discrete components and features which can be readily separated from or combined with the features of any of the other several embodiments without departing from the scope or spirit of the present invention. Any recited method can be carried out in the order of events recited or in any other order that is logically possible.

All existing subject matter mentioned herein (e.g., publications, patents, patent applications and hardware) is incorporated by reference herein in its entirety except insofar as the subject matter may conflict with that of the present invention (in which case what is present herein shall prevail).

Described herein are various methods and systems for testing and computing performance metrics, and in preferred embodiments, for computing a lift value.

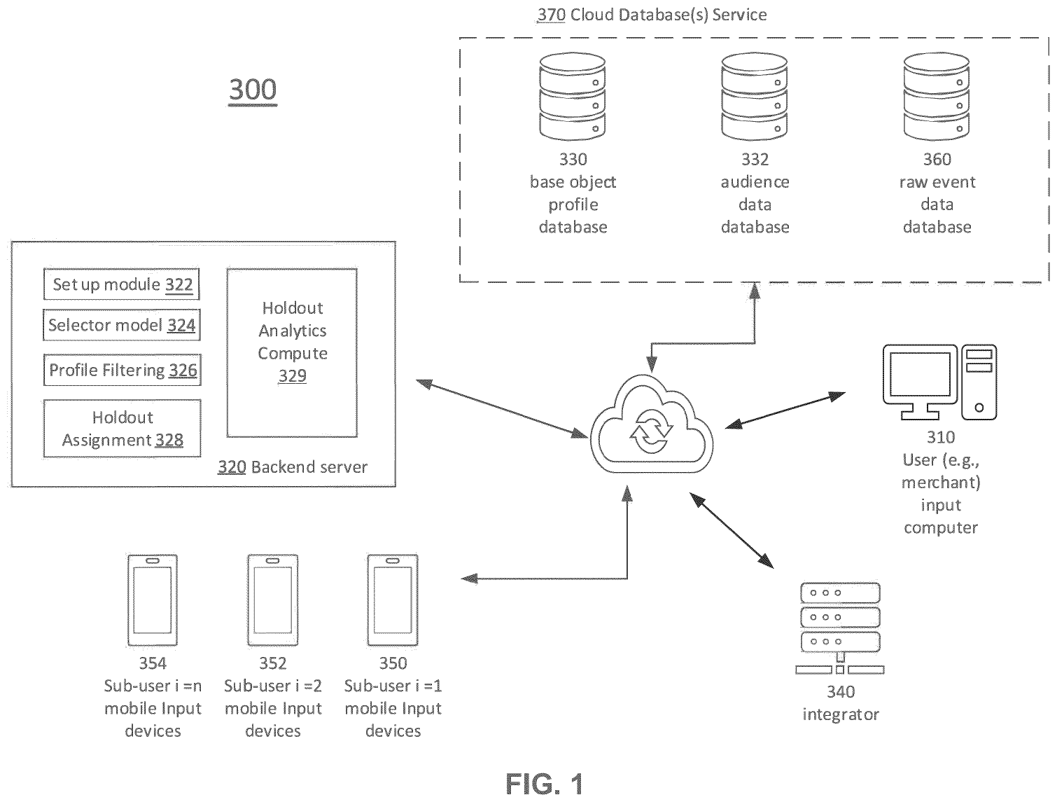

FIG. 1 is a schematic diagram of a system 300 for computing lift and other performance metrics, according to one or more embodiments of the present invention. The system 300 is shown including a user input computer 310, a backend server 320, at least one sub-user input device 350, 352, 354, a profile base object database 330 comprising records organized by sub-user or profile ID, an audience or group membership-type database 332 comprising records organized by groups of the sub-users, and a raw event database 360 for collecting and storing events arising from sub-user behavior.

In embodiments, as shown in FIG. 1, a cloud database service 370 is arranged to implement the base object profile database 330, audience database 332 and raw event data database 360. Various database services such as, e.g., AWS cloud databases provided by Amazon Web Services, Inc. (Seattle, Washington) are operable to store, manage, query, run, and safeguard the information in computer systems. The cloud database service can have a wide range of configurations such, e.g., a network-connected storage, distributed cloud storage, a physical hard drive, or virtual storage. The datastores can store both structured data like tables and unstructured data like emails, images, and videos.

In particular implementations, the data is stored in a column-oriented database management system (DBMS), which can be used for online analytical processing (OLAP). OLAP databases are programmed and operable to perform aggregations on, optionally, huge datasets in fractions of a second. An example of a OLAP database is, without limitation, ClickHouse or ClickHouse Cloud, both by ClickHouse, Inc. (Amsterdam, NL). Indeed, the implementation of how the data is collected, processed, published, and written may vary widely.

Optionally, an integrator database 340 is operable to host the user's website and monitor behaviors of the sub-users. In some embodiments, the user 310 is a merchant selling products or services to the sub-users 350, 352, 354 through a website operated by the integrator 340 (e.g., Shopify). When the user desires to understand the impact electronic messages have on its sub-users 350, the user can make a request to the backend server 320 to perform testing and compute a lift value and other metrics arising from all types of electronic messages being delivered, described further herein.

The backend server 320 is shown having a user setup or configuration module 322, selector model 324, profile filtering 326, holdout assignment module 328, and holdout analytics compute 329. Each of these functional modules is described herein in connection with various methods for testing and computing a lift value.

Also, although FIG. 1 refers to sub-user mobile input devices, the invention is not intended to be so limited. The invention is also applicable to non-mobile-type sub-user input devices including, e.g., a desktop computer.

### Overview Method for Computing Lift

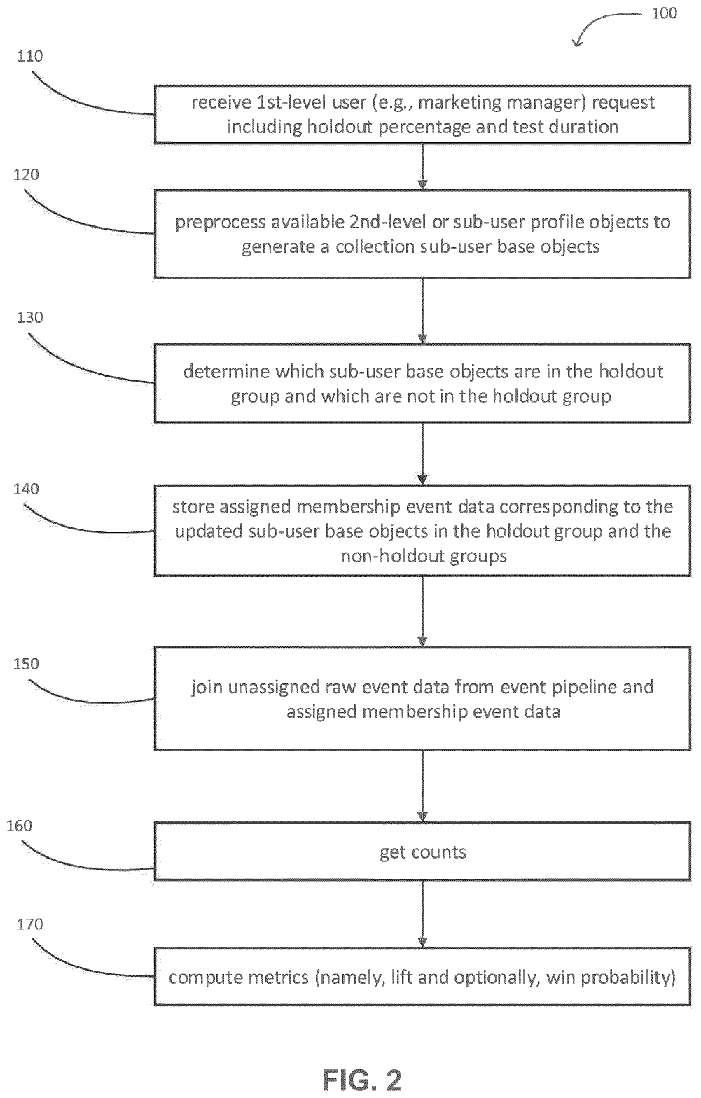

FIG. 2 is a flowchart illustrating an overview of a process 100 for computing a lift value, according to one or more embodiments of the present invention.

Step 110 states to receive a 1st-level user (e.g., marketing manager) request including holdout percentage and test duration. In embodiments, the setup module 322 is operable to request this information from the user. In embodiments, the user enters testing parameters including, e.g., the percentage of valid sub-user profiles to be included in the holdout group (i.e., a designated group of valid profiles not to receive any type of electronic messaging). An exemplary holdout size is between 0.1 and 10% of the total valid profiles. An exemplary number of valid sub-users is 400,000 or more. An example of a profile that is not marketable or valid is, without limitation, phone numbers that have not explicitly consented and push notifications that have not explicitly consented. Also, an example of a profile that should always receive marketing communications and never be held out is a VIP. In embodiments, a VIP is a profile base object in a class or group of high value customers determined by various VIP criteria. Examples of VIP criteria include, without limitation: high customer lifetime value, frequent repeat purchases, high average order, and frequent engagement with communications (e.g., high open rate, click-throughs, etc.)

An exemplary duration is 3 months or longer. However, in embodiments, the user can stop the testing at any time.

In embodiments, the server or API is operable to recommend or otherwise provide a default holdout size and duration. In embodiments, a default holdout size and duration presented to the user is 5% and 3 months, respectively. The user can then accept or adjust the default settings. However, in embodiments, the server is programmed to gate the entire process based on a minimum number of valid profiles from which to choose the holdout size. In embodiments, the gating threshold for computing lift is 400,000 valid profiles.

Step 120 states preprocess available 2nd-level (e.g., customer) or sub-user profile base objects to generate a collection sub-user base objects. As described further herein, in embodiments, this step is performed by the selector and filtering modules 324, 326 of the backend server 320 applying a set of rules and models to obtain a reduced set of marketable profiles or valid profile base objects from the profile base object database 330.

Step 130 states to determine which sub-user base objects are in the holdout group and which are not in the holdout group. This step can be performed by the holdout assignment module 328 of the backend server 320. As described further herein, one or more types of algorithms can be applied to assign the profile base objects to the holdout group and to the non-holdout. In embodiments, the valid profile base objects are hashed to create reduced-size deterministic hashed profile records for the holdout group and the non-holdout group.

Step 140 states to store the assigned membership event data corresponding to the updated sub-user base objects for the sub-users in the holdout group and the non-holdout group. This step may be performed by writing the assigned membership event data corresponding to the updated assigned sub-user base objects to an internal analytical database (e.g., group/membership base object database 332). In embodiments, assignments of the sub-user base objects are not stored to the sub-user base object database as that could affect many downstream actions based on the existing organization and schemas in the sub-user base object database.

In embodiments, electronic communications (e.g., electronic communications arising from automations such as flows or from marketing campaigns) can be sent without waiting for membership/audience creation in step 140 to be completed. It is an advantage of embodiments of the invention that audience creation can be asynchronous and doesn't interrupt the 1st-level user's workflow.

Step 150 states to join unassigned raw event data from an event pipeline (e.g., unassigned raw events in the raw event database 360 arising from current flows and campaigns) and the assigned stored membership data from the audience pipeline (e.g., the assigned events in the group/membership base object database 332). This step can be performed by the group/membership base object database 332, or more generally the datastore 370 as instructed by the backend server 320, described further herein. In embodiments, an advantage of the method arises from generating the joined assignments for the holdouts and non-holdouts on the lift request, and not based on previously stored metadata in the profile or sub-user base objects.

Step 160 states to get counts. This step can be performed by querying the group/membership database 332 as instructed by the backend server 320, described further herein. The database 332 is programmed and operable to return the counts, preferably in fractions of a second.

Step 170 states to compute metrics (namely, lift and optionally, win probability). This step can be performed by the holdout analytics compute 329 of the backend server 320. Optionally, the data can be computed and displayed as described further herein.

### Detailed Method for Computing Lift

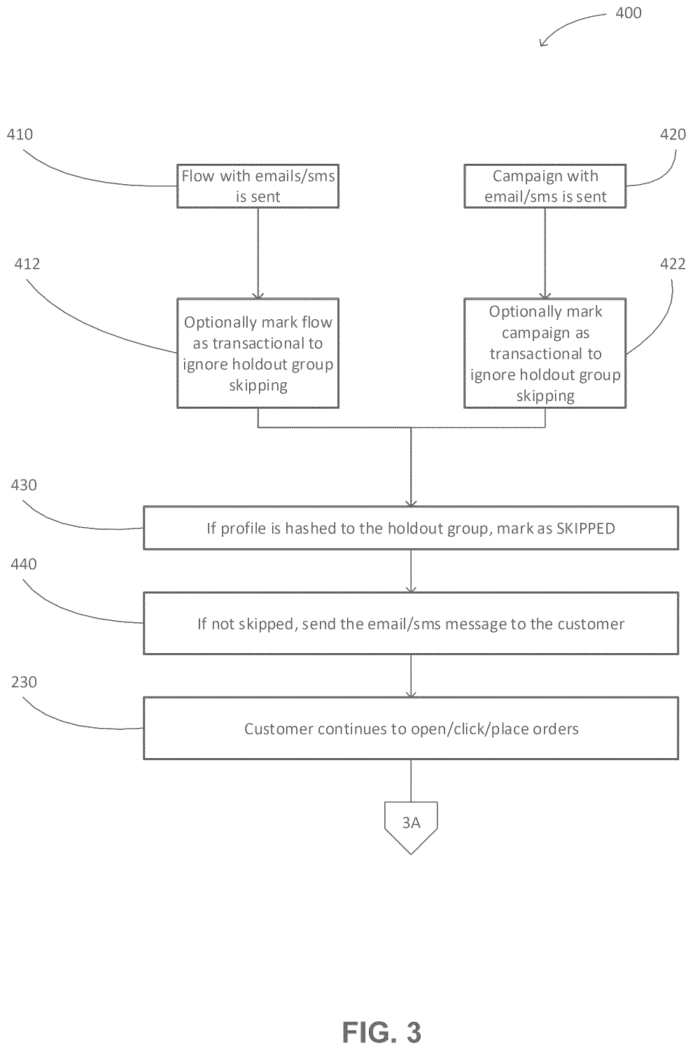

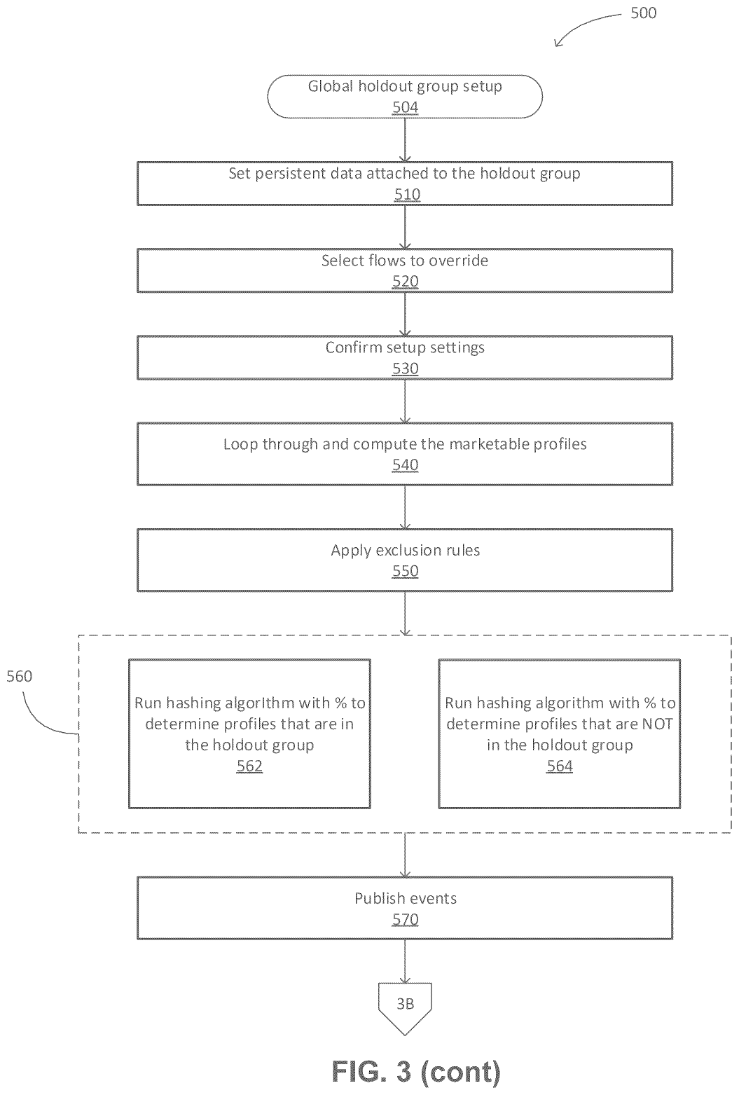

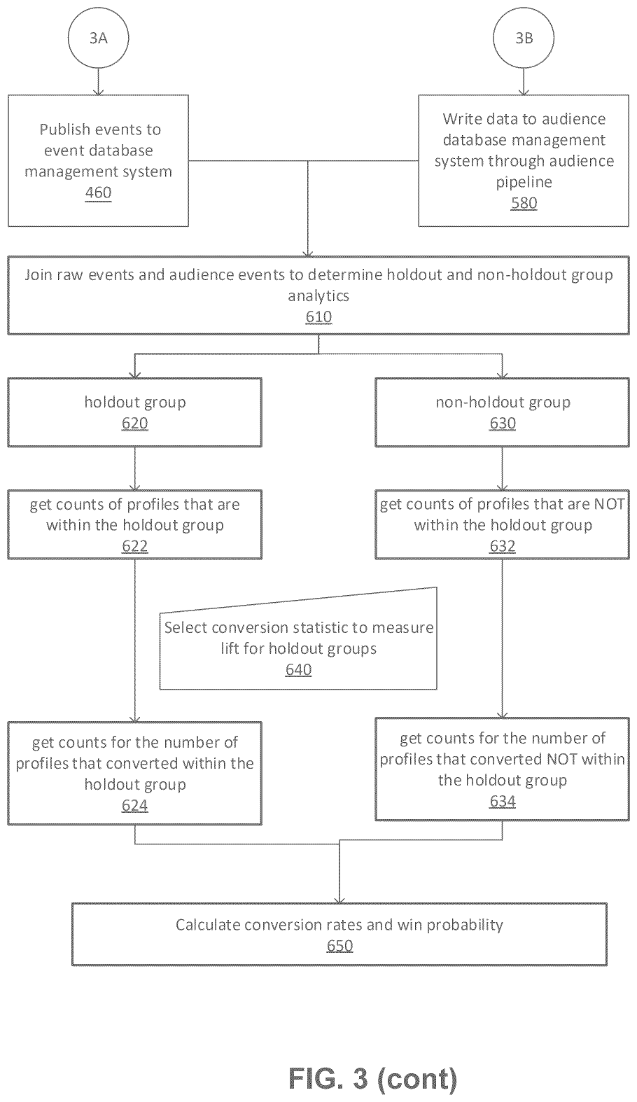

FIG. 3 is a flowchart illustrating a process for computing a lift value, according to one or more embodiments of the present invention.

The process in FIG. 3 is shown having two pipelines: (a) a holdout assignment pipeline 500 and (b) a raw event pipeline 400. The events arising in the raw event pipeline are unassigned, i.e., they are not labeled are otherwise identified as members of the holdout group or non-holdout group.

With initial reference to the holdout assignment pipeline 500, step 504 states global holdout group setup. This step can be performed via the setup module 322 of the backend server and an API by which the user (typically, a marketing manager of the user) requests on its computing input device 310 to commence an experiment and in particular, to commence a global holdout experiment.

Examples of experiments include A/B testing. Examples of A/B testing are described in US Patent Publication No. 20240394746, filed Feb. 27, 2024, and entitled “Determining Winning Arms of A/B Electronic Communication Testing Using Resampling-Based Bayesian Nonparametrics”; and US Patent Publication No. 20230409821, filed Aug. 27, 2023, and entitled “Automated Testing of Templates of a Mobile Message”, each of which incorporated herein by reference in its entirety for all purposes.

Next, and with reference to step 510, the method states to set persistent data attached to the holdout group. Examples of such data include the holdout percentage of valid sub-user profiles and test duration of an experiment. In embodiments, this step is performed by the user entering testing parameters including, e.g., the percentage of valid sub-user profiles to be included in the holdout group (i.e., a designated group of valid profiles not to receive any type of electronic messaging). An exemplary holdout size is between 0.1 and 10% of valid profiles, and preferably with a minimum number of valid profiles. In embodiments, the threshold number of valid profiles (i.e., a gate feature for proceeding to compute lift) is greater or equal to 400,000 valid profiles.

In embodiments, the server is operable to provide a candidate holdout size based on an algebraic formula or, in some embodiments, a power analysis. In embodiments, in order to ensure a minimum size in the holdout group, a threshold holdout size is required. In embodiments, the threshold holdout size is 0.1% of valid profiles

In embodiments, the customer setup module 322 is also operable to recommend or otherwise provide a default holdout size and duration. In embodiments, a default holdout size and duration presented to the user is 5% and 3 months, respectively. The user can then accept or adjust the default settings via the UI.

Additionally, in embodiments, the user can stop the testing at any time.

Step 520 states to select flows to override as, e.g., ‘transactional’ so that the selected flows will be ignored by the holdout exclusion.

A flow is an automated series of steps triggered by an activity or behavior. Flows are autoresponders that can contain one or more emails and text messages and can be configured to send to contacts after a range of different tracked events occur. Certain electronic messages in a flow may be desired to be delivered to the recipients. For example, a purchase confirmation is considered a transaction and is desired to be delivered. Additionally, a user may also desire to deliver (and not holdout) other types of electronic messages (e.g., non-transactional) such as an important notification or a discount for a particular good customer.

Similarly, a user may select a campaign to override. A campaign is a single, targeted email sending effort; a one-time send to a pre-established group of sub-users (sometimes referred to herein as an ‘audience’). The electronic messages in a campaign may be desired to be delivered to the recipients. For example, electronic messages corresponding to a particular holiday campaign or elite customer discount may be considered too important to holdout.

Indeed, this step 520 allows for flexibility and customizations to the electronic messages slated to be in the holdout group.

In embodiments, this step is performed by the user entering via the user input device the electronic messaging strategies (e.g., flows, campaigns, or notifications) to be excluded from the holdout grouping. The backend server 320 is programmed and operable to collect the user's instructions.

Additionally, in some embodiments, a trained selector model 324 of the backend server 320 is operable to classify existing flows (e.g., a welcome flow, discount flow, etc.) and to provide the available flows as candidates to be excluded from the holdout group. The model may be a rules-based classifier to classify the electronic messaging strategy. The list of candidate flows can be presented alphabetically.

Optionally, the candidate flows are ranked or scored to indicate which is more desirable to exclude from the holdout group. For example, in embodiments, a machine learning model is trained on sets of lift (optionally win probability)-labelled flows. Exemplary categories of machine learning models are the decision tree-based algorithm including, for example, the XGBoost. The inventors recognize it is important to train the model by striking a balance between excluding critical particular electronic messages and decreasing the true lift value—the primary purpose of the testing. Indeed, if one were to exclude all electronic messaging strategies and messages, the testing would be inconsequential.

In embodiments, the user then selects which candidate electronic messaging strategy (e.g., which flow) they desire to exclude from the holdout group.

Step 530 states to confirm the setup settings. This step is performed by the user to confirm (and double check) the above described user inputs including the size of the holdout group, duration of the test, and any customizations or transactional type messages to exclude from the holdout group.

Step 540 states to loop through and compute the marketable profiles. This step is performed by backend server 320 requesting the profile base objects (namely, sub-user base objects) from the profile base object database 330 and excluding or filtering out any of the profiles that are not valid or otherwise not profiles to be tested per step 550.

Step 550 states to apply exclusion rules. In embodiments, profile(s) without electronic messaging consent are excluded. In embodiments of the invention, an action or sub-user behavior is sensed or detected or monitored to trigger an exclusion rule. For embodiments, the exclusion rule is automatically generated for the offending profile. For example, if a bounce arises from sending a first type of electronic message (e.g., email) to a particular sub-user profile, the profile filtering module 326 can create a rule to exclude this profile from the list of valid profiles. Examples of electronic messages to exclude include:
(a) emails that have explicitly suppressed or bounced/revoked consent;
(b) phone numbers that have not explicitly consented;
(c) push notifications that have not explicitly consented.
(d) sub-user profiles that the user has designated as VIPs that should always receive marketing communications and should never be held out.

A complexity solved by the inventors is to query or filter the profile base objects for one type of electronic messaging channel (e.g., emails) differently than another type of electronic messaging channel (e.g., SMS and push notifications) because unlike emails, explicit consent is required by law for SMS and push notifications. This step can be performed automatically by the profile filtering module 326 of the backend server 320.

Step 560 determines which sub-user base objects are in the holdout group 562 and which are not in the holdout group 564. As described further herein, one or more types of algorithms can be applied to assign the sub-user base objects or profiles to the holdout group and to the non-holdout or control group. In a preferred embodiment, a hashing algorithm such as, but not limited to, ‘mumurhash’ is applied. Hashing provides a deterministic way to assign a percentage of sub-user profiles to a group. By deterministic, it is meant that for a given input value the hash procedure must always generate the same hash value. This step may be performed by the holdout assignment module 328 of the backend server.

The inventors recognize that other approaches may be implemented to determine which profiles should be assigned to the holdout and non-holdout groups.

For example, an alternative approach is to populate the internal profile database model (e.g., 330) with an additional piece of metadata that indicates whether a profile was part of a global holdout group. However, this approach would cut across the domains of other existing platforms/service that utilize the internal profile database 330 such as, e.g., campaign sending, flow sending, and event population. Also, adding this ‘holdout’ property to the profile database model would add load/latency to the infrastructure behind these profiles, which is also undesirable.

In contrast, the virtual-like approach described above in connection with step 560 does not require adding a new attribute to the internal profile database model (e.g., profile base object database 330). Rather, the approach described in step 560 checks each profile's membership for being in the holdout group every time it needs to be determined.

The logic rules or code for achieving this step may vary. For embodiments, exemplary code is as follows:
def is_profile_in_holdout_group(holdout_group,profile_id):
hashed_key=MurmurHash.hash(f“{holdout_group.id}_{profile_id}”)
profile_bucket=hashed_key % 100
return profile_bucket<(holdout_group.holdout_percentage)

In this embodiment, because both the profile_id and holdout_group.id were Universally Unique Identifier (UUID) s, we were able to randomly, but deterministically, separate every profile into a holdout or non-holdout group based on whether or not their profile_bucket was less than the holdout group's holdout_percentage. While this does mean we generally run this method for every potential send, the entire function is solely CPU operations, which are orders of magnitude faster than a database lookup. This is a clear advantage over storing the profile holdout membership information in the internal profile base object database, e.g., the profile base object database 330. For embodiments, by storing the holdout membership information in the audience database 332 (which is typically an online analytical processing or ‘OLAP’-type database) instead of the internal profile base object database 330 (which is typically an online transaction processing or ‘OLTP’-type database), no additional latency needs to be introduced on profile object reads/writes for the sake of OLTP guarantees, instead loosening the consistency requirements for OLAP use cases.

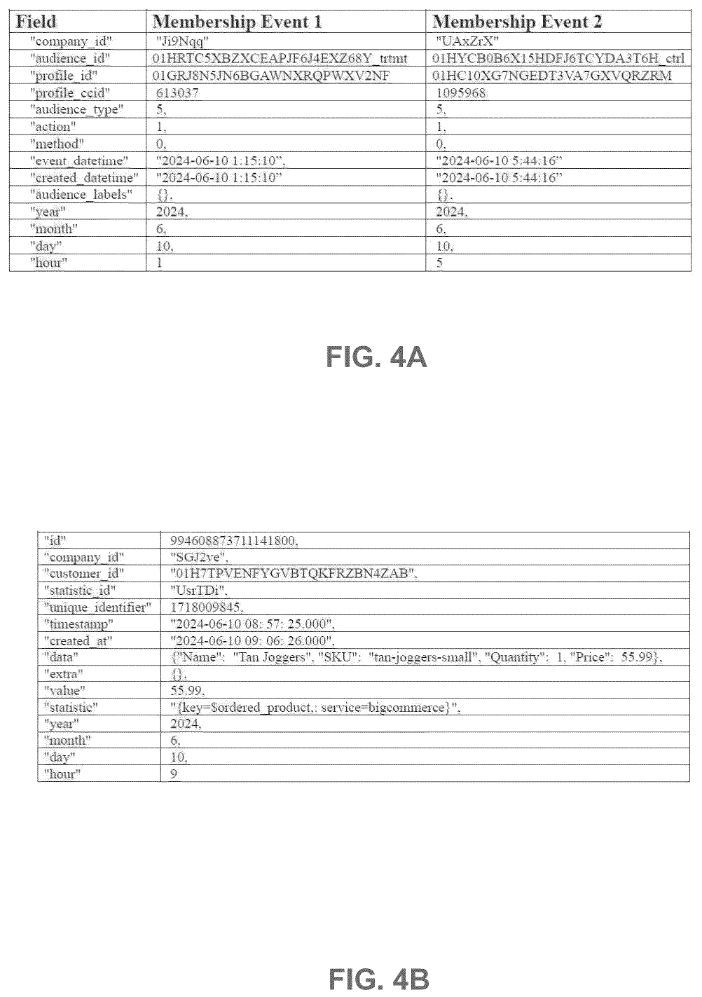

Step 570 states to publish events. In embodiments, events are published to an asynchronous processer. This step is performed by the backend server 320 requesting the assigned membership events for each sub-user profile to be published to the group membership base object database 332. By membership events, it is meant records of group membership including changes to membership. In embodiments, each assigned membership event contains fields for, without limitation, company ID, audience ID, profile ID, timestamp, etc. where the audience ID can denote whether the sub-user is a member of the holdout group or not. Examples of partial records of assigned membership events for publishing are shown in FIG. 4A, where the audience_id corresponds to the holdout counter for labelling whether a profile is assigned to the holdout group (e.g., XXX_trtmt) and the non-holdout group (e.g., XXX_ctrl).

Step 580 states to write data to audience database through the audience pipeline. This step is performed by writing the assigned membership event data published in step 570 to the group membership (namely, audience) base object database 332 for joining with the raw data event pipeline described herein. The data is written here so it may persist and be retrieved later, and in view of the deterministic hashing algorithm, the existing profiles maintain their hash value, and consequently maintain their assigned holdout group.

Optionally, data can be written to the audience database as described in co-assigned U.S. patent application Ser. No. 18/518,238, entitled “Computer-implemented Method for Real-Time Group Membership Tracking and Related System”, filed Nov. 22, 2023, and incorporated herein by reference in its entirety for all purposes.

With reference again to the raw event pipeline 400, step 410 states flow with email/SMS is sent. Similarly step 420 states campaign with email/SMS is sent. Push notifications can also be included in each of the flow and campaigns. These steps are performed by backend campaign and flow management services/platforms to generate and send electronic messages according to the flow and campaign rules.

Additionally, in embodiments, one or more additional integration pipelines generate and collect integration events such as orders placed, orders started, etc. from an integrator 340. These integration events can be generated by an integrator service such as, without limitation, Shopify, BigCommerce, etc. and form a separate ‘integration’ pipeline of unassigned events for the holdout testing.

Steps 412,422 state to optionally mark flow and campaign, respectively, as transactional to ignore holdout group skipping. This step is performed by the user or automatically by the processor in the backend server to ignore holdout skipping for messages corresponding to transactions such as, e.g., payment receipt/confirmation. Additionally, the flows or campaigns are marked to be skipped for other reasons including electronic messages deemed too important to be skipped by the user such as an approved discount anticipated by the sub-user.

This step can be performed via the flows and campaigns services. In embodiments, the flow can be marked when the flow is triggered/scheduled to be sent to a profile and the campaign can be marked when the campaign is scheduled to be sent a list/segment.

Step 430 states that if the profile is hashed to the holdout group, mark as skipped. That is, as described above, if during the setup the sub-user profile was assigned to the holdout group during step 560, then this profile is excluded and should be skipped. Electronic messages arising from the flows and campaigns associated with this profile base object are not sent.

Step 440 states, if not skipped, send the email/SMS message to the sub-user or customer(s). This step can be performed based on instructions from the backend server to send the electronic messaging where the execution can be implemented by a number of different entities such as a host server, a bulk email service provider, or the user's server framework.

Step 450 states the customer continues to open, click, or place orders. This step is performed by the sub-user customer where each such event is detected by the integrator, host server, or otherwise.

In embodiments, an API is operable to sense/detect (in addition to open/click/and place order), scroll time, hover time, bounce, blocked, and location on a window of a sub-user device, as well as geographical location information of the sub-user device. All such information can be used to evaluate candidate exclusions from the holdout group. In embodiments, such information is used as input to the selector model, described above, for selecting candidate flows and campaigns to exclude from the holdout group. Scroll time, scroll location, and geographical location can be indicative of increased or decreased desire to make a purchase. For example, a sub-user scrolling for a long time on a particular item, and in the geographical vicinity of a recognized location requiring the particular item may be grounds to exclude from the holdout group messages to the sub-user(s). The selector model can be trained using such information to optimize which flows and campaigns ought to be candidates for excluding.

Step 460 states to publish events to event clickhouse, e.g., to the raw event database 360, or more generally to datastore 370. In embodiments, each raw event generated by the various services as described above is published to the raw event database 360. At this stage, numerous types of information are stored for each raw event except for whether it is a member of the holdout group or non-holdout group. For example, a partial record of an unassigned raw event for publishing is shown in FIG. 4B where the “customer id” (which corresponds to the “profile id” in the membership event record shown in FIG. 4A) is listed as “01H7TPVENFYGVBTQKFRZBN4ZAB”, ‘company id” is listed as “SGJ2ve”, and the statistic is listed as “ordered product”

### Holdout Analytics Module

Step 610 states to join events from the event pipeline 400 (e.g., unassigned raw events in the raw data database 360 arising from flows and campaign services) and the audience/membership events from the audience pipeline 500 (e.g., assigned membership events stored in the audience base object database 332). This step can be performed by the membership base object database 332, or more generally the cloud based datastore 370.

Optionally, unassigned raw event data arising from an integrator pipeline, described above, can also be joined with the assigned membership events of the audience pipeline 580. Where raw unassigned events from an integrator pipeline are being received, additional steps can be performed to assign the profiles as holdout and not holdout members, and to override certain electronic messaging strategies (e.g., transactional payment confirmation).

In embodiments, all the types of events are joined by matching unassigned raw events from the datastore 370 in the first pipeline (e.g., 460) with assigned membership events in the datastore of the second pipeline (e.g., 580) on the profile ID fields to generate a holdout group of events and a non-holdout group of events corresponding to steps 620, 630 respectively.

For embodiments, for each of the holdout group and non-holdout group, a comprehensive table of joined events, in standardized arrangement with duplicate records removed, where for each profile ID, there is at least a column for event ID, audience ID (e.g., holdout or non-holdout group), company ID, and metrics or statistics tracked (e.g., placed orders, orders started, etc.).

Step 622 states to get counts (of events) of profiles that are within the holdout group. This step can be performed by the group membership database 332/datastore 370.

Step 632 states to get counts (of events) of profiles that are NOT within the holdout group. This step can also be performed by the database 332/datastore 370.

Step 640 states to select conversion statistic to measure incremental lift for holdout groups. Non limiting examples of conversion statistics to measure are: open carts, checkouts started, and purchases. In embodiments, a default conversion statistic is used to compute lift. In some embodiments, the user is prompted to confirm the default conversion statistic during setup (e.g., step 504). In embodiments, the server is operable to allow the user to enter the conversion statistic after displaying the initially computed conversion rates, discussed herein. For example, if the conversion rates are computed for placed orders, the user can request to see the lift value for “orders started”. The method then recomputes the lift for the new type of statistic requested.

Step 624 states to get counts (of events) for the number of profiles that converted within the holdout group. This step can also be performed by the database 332/datastore 370.

Step 634 states to get counts (of events) for the number of profiles that converted NOT within the holdout group. This step can also be performed by the backend server 320 making a request to the database 332/datastore 370.

Step 650 states to compute conversion rates for each of the holdout group and non-holdout group, and preferably, the lift value. This step can be performed by the hold out analytic engine 329 of the backend server 320 based on the counts received from the database described above.

In embodiments, by “lift value” it is meant the increase in percentage of the conversion rate of the treatment or test group to the conversion rate of the holdout group.

In embodiments, the win probability is computed. By win probability it is meant how likely it is that the winning variation truly had the highest conversion rate (e.g., placed order rate) after taking random chance into account, and whether this probability is considered statistically significant. Win probability can be computed as described in U.S. Pat. No. 11,783,122, entitled “Automated Testing of Templates of a Mobile Message”, issued Oct. 10, 2023, and incorporated herein by reference in its entirety for all purposes. In embodiments, win probability is based on Bayes' formula.

### Example

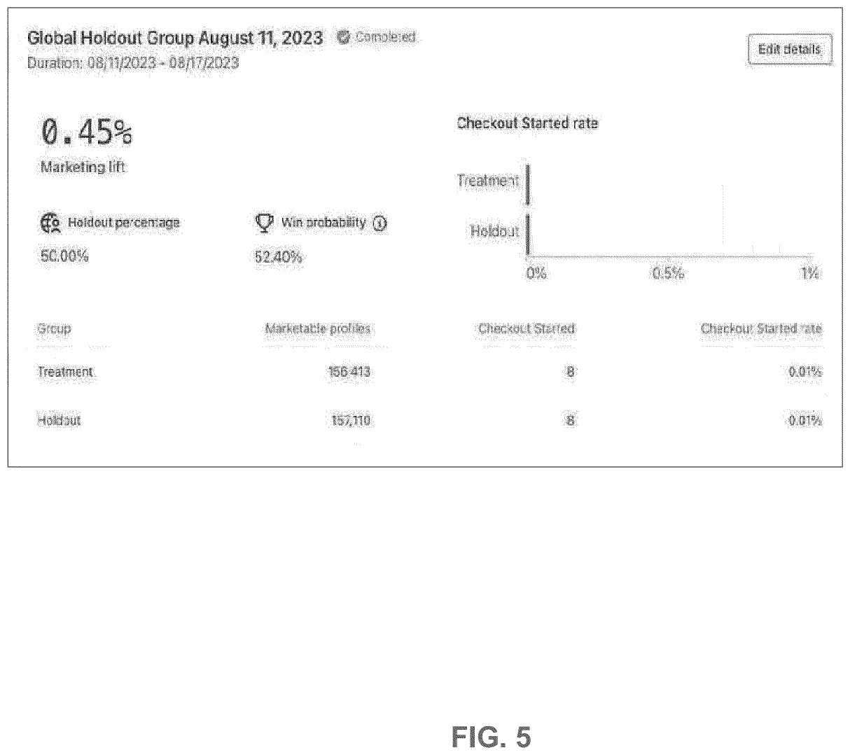

FIG. 5 is an example of a report card for displaying the testing data and results in accordance with embodiments of the invention. In particular, FIG. 5 shows a graphical user interface (GUI) for a global holdout group dated Aug. 11, 2023 in accordance with an embodiment of the invention.

The report includes a plurality of regions or windows: (a) upper left regions shows duration of the test from “Aug. 11, 2023-Aug. 17, 2023” and the lift percentage of 0.45%.

Underneath the lift is the holdout percentage and win probability. Holdout percentage is the number of marketable profiles in the holdout group to the total number of marketable profiles. Win probability, as stated above, is how likely it is that the winning variation (the treatment group) truly had the highest conversion rate (where in FIG. 5, the conversion statistic is ‘checkout started’) after taking random chance into account, and whether this probability is considered statistically significant.

The upper right window shows a bar chart for the conversion rate (%) for the treatment group versus holdout group, which in this example is 0.01%.

The lower window is divided into 4 columns including the group, number of marketable profiles in each group, conversion count in each group, and the conversion rate.

The data indicates both groups have eight (8) conversions (i.e., “checkout started”). But, because there are about 700 less marketable profiles in the treatment group than the holdout group, the lift is 0.45% and the win probability is 52.40%.

While the treatment group provides a 52.40% win probability, it may be considered not statistically significant. A statistically significant win probability typically means the treatment group has a high win probability (e.g., at least 90%).

It is to be understood, however, that the above reports and metrics shown in FIG. 5 is an example and the invention is not intended to be limited to these examples except where specifically recited in any appended claims. A wide range of reports may be generated by the database management system in granularity and in seconds or fractions of a second.

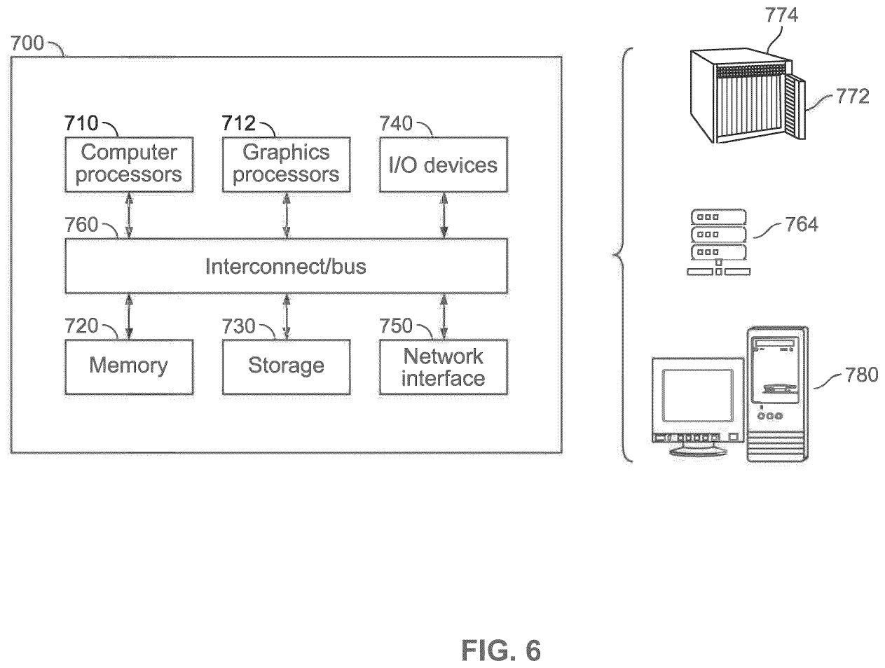

FIG. 6 is a block diagram of a computing system 700 used to implement the techniques/processes described herein in accordance with embodiments of the invention. The computing device 700 is intended to represent various forms of digital computers, such as servers 764, 774, workstations, desktops 780, laptops, and other types of computing devices. The components shown here, their connections and relationships, and their functions, are meant to be exemplary only, and are not meant to limit implementations of the inventions described and/or claimed herein.

The computing device 700 is shown including: a computer processor 710, graphic processor 712, memory 720, storage 730, input output devices 740 and network interface 750.

The processors 710, 712, memory 720, storage 730, and network interface 750 can be interconnected using various interconnect busses 760, and may be mounted on a common motherboard or in other manners as appropriate. The processor(s) can process instructions for execution within the computing device 700 to carry out the operations described herein, and including instructions stored in the memory 720 to display graphical information for a GUI on a display unit coupled to the network interface, I/O ports, or dedicated video card (not shown).

The memory 720 stores information within the computing device 700. In some implementations, the memory 720 is a volatile memory unit or units. In some implementations, the memory 720 is a non-volatile memory unit or units. The memory 720 may also be another form of computer-readable medium, such as a magnetic or optical disk.

The storage device 730 can provide mass storage for the computing device 700. In some implementations, the storage device 730 may be or contain a computer-readable medium, such as a hard disk device, an optical disk device, a tape device, a flash memory or other similar solid state memory device, or an array of devices, including devices in a storage area network or other configurations.

In some implementations, a computer program product may also contain instructions that, when executed, perform one or more methods, such as those described above. The computer program product can also be tangibly embodied in a computer- or machine-readable medium or media, such as the memory 720 or the storage device 730.

The input/output devices 740 are connected to the system via an input/output interface. Examples of input/output devices include, without limitation, sensors such as touch screen sensors, geolocation receivers, microphones, speakers, keyboard, mouse, printer, Bluetooth peripherals, and USB devices to communicate with the internal components of the computing device. In some embodiments, a user behavior or selection may be obtained or sensed by the input output devices, and used for testing setup, to determine exclusion rules, and to select metrics as described herein.

Network interface 750 can include various communication ports (e.g., USB, Bluetooth, Ethernet, wireless Ethernet). The network interface 750 can allow the processors to access the Internet through wired or wireless connections such as WiFi, 3G, 4G long-term evolution (LTE), 5G, and other wireless interface standard radios as well as Ethernet connection hardware.

The computing device 700 may be implemented in a wide variety of different forms. For example, it may be implemented as a standard server 764 or a desktop computer 780.

In some embodiments, multiple processors and/or multiple buses are combined, as appropriate, along with multiple memories and types of memory. Multiple computing devices may be connected, with each device providing portions of the necessary operations (e.g., as a server bank, a group of blade servers, or a multi-processor system). Examples of server systems for implementing the processes and methods described herein include, without limitation, cloud data centers including cloud storage and datastores, and optionally arranged as rack-mounted servers 764, blade server systems 774, or otherwise.

In embodiments, different servers (optionally at different locations) carry out different steps or processes of the invention. For example, an audience server may be programmed and operable to manage the collection and storage of group membership, an events server may be programmed and operable to manage collection and storage of the raw events, and a profile or sub-user database server may be programmed and operable to manage the database for profile information and metrics. In a preferred embodiment, the server may be configured as a server framework, cluster, or distributed computing system of servers or nodes to perform the steps, and serving to distribute workloads consisting of a high number of individualized, parallelizable tasks among the nodes in the cluster. A non-limiting example of a suitable distributed computing system is AWS by Amazon Web Services, Inc. (Seattle, WA). In embodiments, the profile base object database, the raw event base object database, the joining operations, and the getting or counting operations are all implemented by a datastore. Indeed, the components shown here, their connections and relationships, and their functions, are meant to be exemplary only, and are not meant to limit implementations of the inventions described and/or claimed herein.

### Alternative Embodiments

In another embodiment, the sub-user's actions are sensed. For an embodiment, when the sub-user loads a webpage, user-tracking code is loaded in through a JavaScript bundle and utilized within the browser of the sub-user. For an embodiment, actions of the sub-user on the website of the user can be tracked. In some embodiments, the amount of time a sub-user's cursor hovers over an area (e.g., a window, tab or icon) of the display is detected. Further, in some embodiments, a mobile device of a sub-user can be tracked to determine other possible actions of the sub-user. In some embodiments, the location or distance a sub-user's mobile device is from a known or target location (and the duration) is detected and tracked. In embodiments, forms that have been filled out and submitted to the website of the user can be monitored and tracked. For an embodiment, behavior of the sub-user's internet browser or device (that would affect communication of a message or a sub-user's desired action) can be monitored or tracked. For an embodiment, navigation by the sub-user to a website or URL (universal resource locator) can be sensed, tracked, and monitored. In embodiments, such information can be used to compute conversion rates, and consequently, to determine lift and win probability.

Additionally, in embodiments, the set of sub-user profiles is not static once the holdout group is established. New marketable profiles may be created and unmarketable existing profiles can be marked as unmarketable. The new profiles are added to the correct audience based on the hashing algorithm, and unmarketable profiles are removed.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in another order than that specifically described above. Additionally, any of the components and steps described herein may be combined with one another in any logical manner except where such components or steps would be exclusive to one another. Accordingly, the scope and spirit of the invention should be judged in terms of the claims, which follow as well as the legal equivalents thereof.

What is claimed is:

1. A computer-implemented method for computing a lift value for global holdout testing, wherein the global holdout testing measures conversions for multiple types of electronic messages and sending strategies, the method comprising:
receiving a plurality of testing parameters comprising holdout percentage for a holdout group and test duration;
selecting electronic message sending strategies to override from the holdout group;
retrieving, from a profile base object database, valid profile base objects;
preprocessing the valid profile base objects based on a set of exclusion rules;
assigning, by a server, profile base objects to the holdout group and profile base objects to the non-holdout group;
publishing asynchronously, in batches, assigned membership event base objects corresponding to the holdout group and the non-holdout group;
joining, by profile, the assigned membership event base objects and unassigned raw event base objects received from a raw event pipeline to create an updated set of event base objects for the holdout group and for the non-holdout group;
calculating total counts of the event base objects in the holdout group and total counts of the event base objects in the non-holdout group;
calculating conversion counts of conversion events for the event base objects in the holdout group and conversion counts for conversion events for the event base objects in the non-holdout group; and
computing, by the server, at least one conversion rate based on the test duration, conversion counts, and total counts.

2. The method of claim 1, wherein the conversion count is based on a statistic type selected from the group comprising purchases, open carts, and checkouts started.

3. The method of claim 1, wherein the messaging strategy types include one-time manual message sends and automatic sends based on trigger events.

4. The method of claim 1, wherein the selecting step is performed by a selector model operable to classify candidates to override from the holdout group.

5. The method of claim 1, wherein the assigning is performed by a hashing algorithm.

6. The method of claim 1, wherein the assigning is performed in real-time within volatile memory structures without committing data to persistent storage mediums.

7. The method of claim 1, further comprising computing a win probability.

8. The method of claim 7, wherein the win probability is based on the Bayes' formula.

9. The method of claim 1, wherein the selecting step comprises identifying messages automatically triggered based on a sub-user detected behavior.

10. The method of claim 1, wherein the exclusion rules are based on excluding profile base objects from the holdout group and are based on channel permissions and optionally, whether profile base object is a VIP.

11. A system for computing lift for global holdout testing, wherein the global holdout testing measures conversions for multiple types of electronic messages and sending strategies, the system comprising:
a raw event database operable to manage raw event base objects arising from sub-user behaviors;
a profile database operable to manage profile base objects corresponding to the sub-users;
a holdout compute engine operable to assign the profile base objects to a holdout group and to a non-holdout group;
a membership database operable to:
arrange and store the profile base objects of the sub-users according to holdout group and a non-holdout group;
publish assigned membership event base objects corresponding to each of the profile base objects in the holdout group and the profile base objects in the non-holdout group;
join, by sub-user, unassigned raw event base objects with the assigned membership event base objects and create an updated set of assigned event base objects for the holdout group and for the non-holdout group
a user interface module operable to request testing parameters comprising holdout percentage for a holdout group, and test duration; and
wherein the holdout compute engine is further operable to:
request, from the membership database, total counts of the assigned event base objects in the holdout group and total counts of the assigned event base objects in the non-holdout group;
request, from the membership database, conversion counts of the conversion events for the assigned event base objects in the holdout group and conversion counts for the conversion events for the assigned event base objects in the non-holdout group; and
compute at least one conversion rate based on the test duration, conversion counts, and total counts.

12. The system of claim 11, further comprising a selector module operable for selecting electronic message sending strategies to override from the holdout group.

13. The system of claim 12, wherein the messaging strategy types include one-time manual message sends and automatic sends based on trigger events.

14. The system of claim 12, wherein the selecting is performed by a selector model operable to classify candidates to override from the holdout group.

15. The system of claim 11, wherein the assigning is performed by a hashing algorithm.

16. The system of claim 15, wherein the holdout compute engine is operable to assign in real-time within volatile memory structures without committing data to persistent storage mediums.

17. The system of claim 11, wherein the holdout analytics server is further operable to compute a win probability.

18. The system of claim 12, wherein the selecting comprises identifying messages automatically triggered based on a sub-user detected behavior.

19. The system of claim 11, wherein the exclusion rules are based on excluding profile base objects from testing unless a first type of sub-user behavior is detected/confirmed.

20. A non-transitory machine-readable medium, comprising executable instructions that, when executed by a processing system including a processor, perform operations for computing lift, the operations comprising:
selecting electronic message sending strategies to override from a holdout group;
retrieve, from a profile base object database valid profile base objects;
preprocessing the valid profile base objects based on a set of exclusion rules;
assigning a first set of profile base objects to the holdout group and a second set of profile base objects to the non-holdout group;
publishing asynchronously, in batches, assigned membership event base objects corresponding to the profile base objects in the holdout group and the profile base objects in the non-holdout group;
joining, by a profile ID, the assigned membership event base objects and unassigned raw event base objects received from a raw event pipeline, thereby creating an updated set of assigned event base objects in the holdout group and in the non-holdout group;
getting total counts of the assigned event base objects in the holdout group and total counts of the assigned event base objects in the non-holdout group;
getting conversion counts of conversion events of the assigned event base objects in the holdout group and conversion counts of the conversion events of the assigned event base objects in the non-holdout group; and
computing at least one conversion rate based on the test duration, conversion counts, and total counts.
